(19) United States
(12) Patent Application Publication
(10) Pub. No.: US 2002/0179414 A1
(43) Pub. Date: Dec. 5, 2002

(54) Transporting apparatus, in particular transporting belt

(76) Inventors: Christian Wullschleger, Solothurn (CH); Ferdinand Meile, Solothurn (CH); Christof Steffen, Boll (CH)

Correspondence Address: Gregory P. LaPointe, BACHMAN & LaPOINTE, P.C., Suite 1201, 900 Chapel Street, New Haven, CT, 06510-2802, US

(21) Appl. No.: 10/153,126

(22) Filed: May 21, 2002

(30) Foreign Application Priority Data
May 25, 2001 (DE) 101 25 854.2

(51) Int. Cl. B65G 23/44

(52) U.S. Cl. 198/810.01

(57) ABSTRACT

In the case of a transporting apparatus, in particular a transporting belt with a tensioning arrangement (6), which butts against a conveying element (3), which is guided over at least two deflecting rollers (1) and is in engagement with at least one drive element (5), the intention is for the at least one tensioning arrangement (6) to be formed from at least two deflecting elements (7) mounted in a moveable manner, at least two deflecting elements (7) being coupled to one another.

### BACKGROUND OF THE INVENTION

The present invention relates to a transporting apparatus, in particular a transporting belt with a tensioning arrangement, which butts against a conveying element, which is guided over at least two deflecting rollers and is in engagement with at least one drive element.

Such transporting apparatuses, in particular transporting belts, are commonly available on the market in many forms and configurations. They serve essentially for transporting and conveying different articles, loads of all types. In the case of conventional transporting belts, the maximum transportable load is determined, on the one hand, by the drive power available and, on the other hand, by the power which can be transmitted to the conveying element. This power is dependent on the angle of wrap of the conveying element around the operating element and on the coefficient of friction between the drive element and the conveying element in accordance with the following relationship (in accordance with Eytelwein): F₁ max.=F₂×e^{μα}, where F₁ is the force in the tension strand and F₂ is the force in the idle strand (e=base of the natural logarithm, μ=coefficient of friction between the drive element and conveying element, α=angle of wrap of the conveying element around the drive element).

If a load is transported on the transporting belt, then this produces, at least on the underside of the belt, a frictional force which is transmitted to the drive element by the belt. This force results in the tension strand, in particular in the case of narrow belts, expanding. In order that the above-mentioned conditions between F₁ and F₂ remain fulfilled, the idle strand has to shorten by the amount by which the tension strand lengthens or, in other words, a minimal force F₂ has to be maintained in the idle strand if a certain force F₁ is to be transmitted from the drive element to the conveying element.

This is achieved in practice by the conveying element being pretensioned to the extent where, on the one hand, the available drive power can be utilized and, on the other hand, the sum of the pretensioning and load-induced tensioning does not damage the conveying element, for example by over-expansion. In a typical application case, this procedure results in the conveying element being pretensioned to the extent where it would be capable of transporting the maximum transportable load even though this never arises. As a result of the permanent, high pretensioning, then, the bearings of the deflecting and drive elements are also subjected to unnecessary loading, which shortens the service life of these parts.

The object of the present invention is to provide a transporting apparatus of the type mentioned in the introduction which eliminates the abovementioned disadvantages and by means of which, in a straightforward, cost-efficient and effective manner, on the one hand it is ensured that the relationship between F₁ and F₂ is maintained permanently and automatically and, on the other hand, the tension strand is only subjected to the loading necessary to provide the transporting power at any one moment in time. In this case, the intention is to reduce the frictional forces and to increase the service life of the conveying elements, and it is to be possible for the dimensioning and configurations of the bearing elements of drive elements to be optimized. It is also to be possible for such a transporting apparatus to compensate automatically, by purely mechanical means, differences in the tensile forces on the conveying element, even in the case of changing loads and accelerations.

### SUMMARY OF THE INVENTION

The foregoing object is achieved wherein at least one tensioning arrangement is formed from at least two deflecting elements mounted in a moveable manner, these deflecting elements being coupled to one another.

This means that a spacing between the two deflecting elements is kept permanently constant, for example by means of a connecting element such as a tie rod, pulling cable or the like. A drive element, in particular the drive roller thereof, is mounted between the two deflecting rollers, preferably at a selectable distance therefrom, the deflecting elements and the drive element having the conveying element wrapped around them.

If the load and/or the acceleration changes, then the tension strand, as a result of the higher force (F₁) prevailing on it, moves the coupled deflecting elements in the same direction as the transportable articles, the deflecting element which has the idle strand wrapped around it ensuring that the idle strand is tightened (retensioned). In this case, the angle of wrap of the conveying element around the drive element remains approximately the same.

This makes it possible to reduce, in particular, the pretensioning forces of the conveying element, with the result that they can thus be compensated automatically, and by purely mechanical means, during operation, even in the case of changing loads and/or accelerations as well as changes in length of the conveying element.

The deflecting elements are preferably located in one plane and are guided linearly in relation to linear guides or the like. It is also conceivable for the deflecting elements, coupled in different planes, to be moved back and forth with one another linearly or on certain radii or curved paths. It is also intended to lie within the scope of the present invention for the two deflecting elements to be pivoted about a center axis of a drive roller, about a radius, or about any other desired axis. This makes it possible to realizes by purely mechanical means, a transporting apparatus, in particular a transporting belt, which, during operation, can absorb even high loads with extremely low levels of pretensioning. In this case, the deflecting elements, in particular the mounting arrangements thereof, are more cost-efficient and the conveying elements may optimally be geared to the requirements of the material which is to be transported, without their expansion behavior having to be taken into consideration.

### BRIEF DESCRIPTION OF THE DRAWINGS

Further advantages, features and details of the invention can be gathered from the following description of preferred exemplary embodiments and with reference to the drawing, in which:

FIG. 1 shows a schematically illustrated side view of a conventional transporting apparatus, in particular of a conventional transporting belt;

FIG. 2a shows a schematically illustrated side view of a transporting apparatus according to the invention in a use position;

FIGS. 2b and 2c show schematically illustrated side views of the transporting apparatus according to the invention from FIG. 2a in a different use position in each case;

FIG. 3 shows a schematically illustrated side view of a further exemplary embodiment of the transporting apparatus according to FIG. 2a;

FIG. 4 shows a schematically illustrated side view of yet another exemplary embodiment of the transporting apparatus according to FIG. 2a;

FIG. 5 shows a side view of a preferred exemplary embodiment of the transporting apparatus according to FIG. 2a; and

FIG. 6 shows a cross section through the transporting apparatus according to FIG. 5, along line VI-VI.

### DETAILED DESCRIPTION

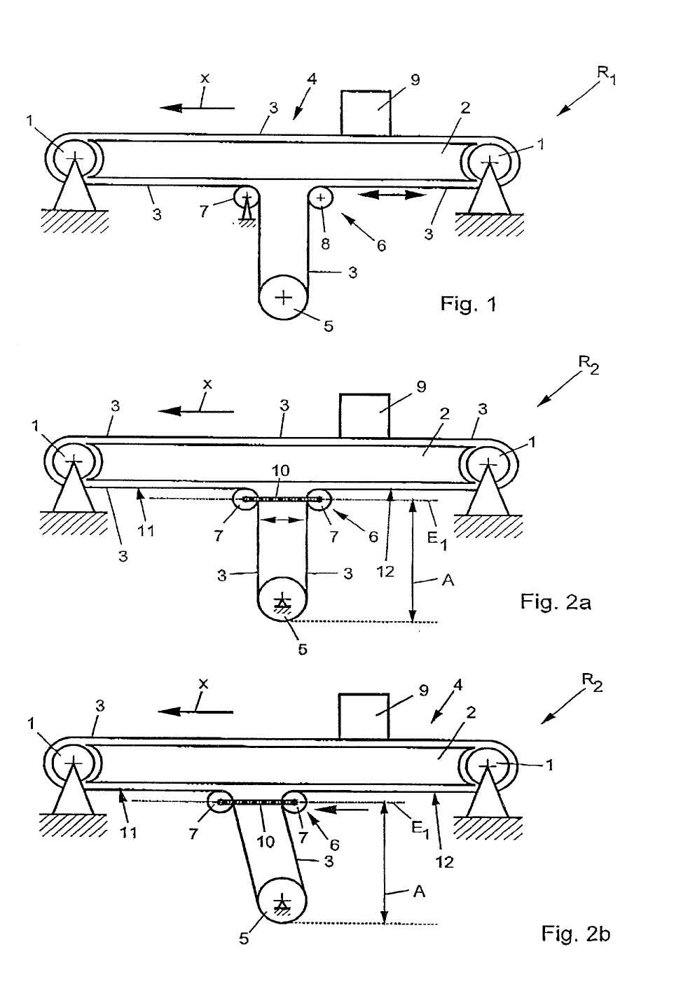

According to FIG. 1, a conventional transporting apparatus R₁, in particular a transporting belt, has at least two deflecting rollers 1, which are spaced apart from one another. A schematically illustrated framework 2 keeps the at least two deflecting rollers 1 spaced apart and supports the transporting apparatus R₁ in relation to the underlying surface, which is not illustrated here.

The deflecting rollers 1 have a conveying element 3 wrapped around them, at least one drive element 5 being provided preferably beneath the framework 2 and beneath a transporting region 4, and it being possible for said drive element to be driven directly or indirectly. The conveying element 3 wraps around a tensioning arrangement 6, which is usually formed from a deflecting element 7 and a tensioning roller 8. The tensioning roller 8, for setting the pretensioning of the conveying element 3, can be set firmly and, as the double-arrow direction X indicates, adjusted. A load 9 can be transported back and/or forth by virtue of the conveying element 3 being moved by means of the drive element 5 in or counter to the X-direction illustrated.

The conveying element 3 is thus kept tensioned in relation to the drive element 5, which may preferably be a drive roller or the like, in order to ensure sufficient static friction for driving and moving the conveying element 3 under different loads 9.

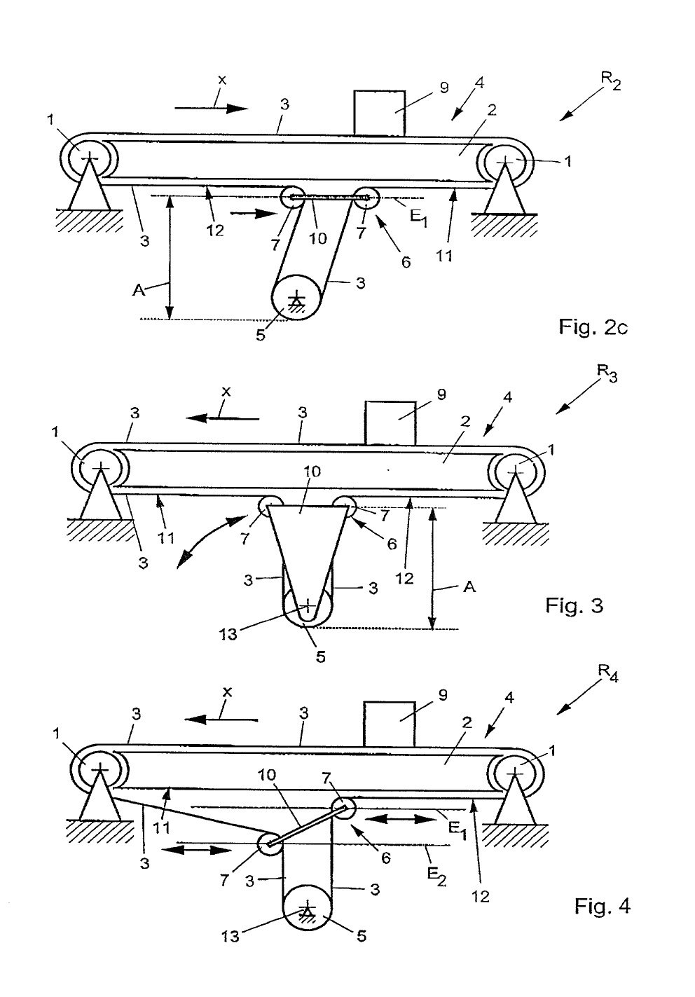

In the case of the present invention, the exemplary embodiment according to FIG. 2a represents a transporting apparatus R₂ according to the invention, in the case of which, preferably in one plane E₁, the tensioning arrangement 6 is formed from two deflecting elements 7 which, as is indicated by the double-arrow direction X, are mounted such that they can be moved back and forth within the plane E₁. The deflecting elements 7 here are coupled to one another via a connecting element 10. The connecting element 10 may be a pulling cable, a tie rod, a plate or the like, which ensures that the two deflecting elements 7 are spaced apart from one another by a selectable distance.

The drive element 5 is preferably arranged centrally between the deflecting elements 7 during operation. The drive element 5 may be driven directly or indirectly via drive motors, servo motors or the like. The drive element 5, in particular the drive roller thereof, preferably has the conveying element 3 wrapped around it, and is kept tensioned by means of the tensioning arrangement 6, in the manner described above.

If, for example, either the conveying speed of the conveying element 3 or the load 9 is increased, then the deflecting elements 7, which are coupled to one another by the connecting element 10, are displaced in direction X as a result of the increase in force in the tension strand 11. In this case, the automatic increase in the length of the idle strand 12 compensates the expansion of the tension strand 11 to the extent where the necessary relationship between F₁ and F₂ is always maintained. The angle of wrap formed by the conveying element 3 around the drive element 5 remains more or less constant during this operation.

It is also ensured, in the case of the present invention, that only an extremely low level of pretensioning of the conveying element 3 by means of the tensioning arrangement 6 is necessary in order to ensure that the conveying element 3 butts permanently against the tensioning arrangement 6 and, in particular, against the drive element 5.

If the conveying speed of the conveying element 3 or the load 9 is reduced, then the coupled deflecting elements 7 are displaced counter to the direction X, as a result of the force decreasing in the tension strand, and reach their “neutral position”, as illustrated in FIG. 2a, when the conveying element 3 is at a standstill and also at constant speed without the load 9.

The change in the conveying direction X results in the coupled deflecting elements 7 also being displaced in the newly selected conveying direction, as is illustrated in FIG. 2c.

The exemplary embodiment according to FIG. 3 represents a transporting apparatus R₃, in the case of which the connecting element 10 ensures that the deflecting elements 7 are coupled in the manner described above, it being possible for these deflecting elements to be pivoted in the manner of a circle arc about a drive axis 13. At the same time, it is possible in the manner described above, when the conveying element 3 is driven in the direction X illustrated, for the tension strand 11 to be shortened and for the idle strand 12 to be automatically tightened. Furthermore, a distance A, as is also illustrated in FIG. 2a, between deflecting elements 7 and drive element 5 is freely selectable.

The exemplary embodiment according to FIG. 4 represents a transporting apparatus R₄, in the case of which the deflecting elements 7 are coupled to one another via the connecting element 10 in the manner described above, but said deflecting elements are located in two different planes E₁, E₂ and are arranged such that they can be moved back and forth only in these planes E₁ and E₂.

It is preferably for the planes E₁, E₂, as is illustrated in FIG. 2a, to be located parallel to one another and parallel to the framework 2 and/or to the transporting region 4 of the transporting apparatus R₄.

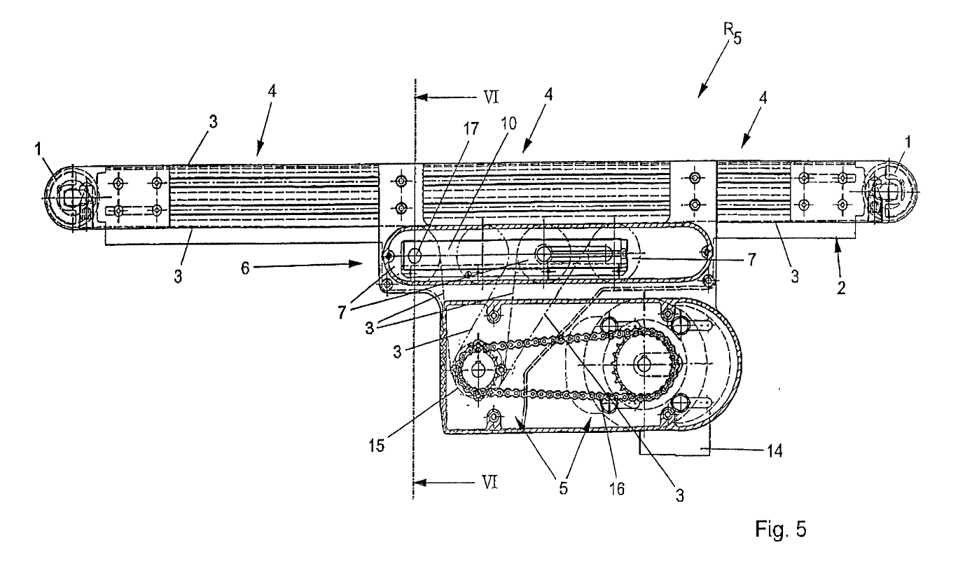

The preferred exemplary embodiment according to FIG. 5 represents a transporting apparatus R₅, in the case of which in the framework 2, indicated by dashed lines, the deflecting elements 7 and the tensioning arrangement 6 are provided beneath the actual conveying element 3 and transporting region 4.

FIG. 5 also shows that the drive element 5, in particular the drive roller 15 thereof, is driven indirectly via a chain 16.

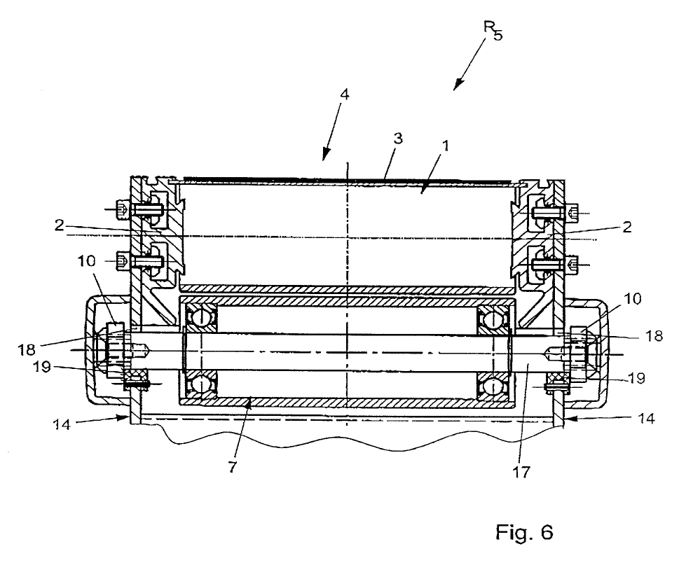

As can be gathered from the partial cross section according to FIG. 6, the deflecting elements 7 are mounted on spindles 17, of which the two ends project into longitudinal slots 18 of the side walls 14 and, resting on sliding supports 19, can be moved back and forth there.

In order to ensure precise parallel guidance, in particular parallel guidance without additional guides for the deflecting elements 7, the connecting element 10 engages over the sliding support 19. If the connecting element 10 is designed, for example, as a pulling cable, in order to connect at least two deflecting elements 7 to one another, then it is also possible for corresponding plates to be positioned on the ends of the spindles 17 from the outside, these butting laterally there against the sliding supports 19 in order to ensure the parallel guidance.

What is claimed is:

1. A transporting apparatus, comprises at least one tensioning arrangement (6) which butts against a conveying element (3) and which is guided over at least two deflecting rollers (1) and is in engagement with at least one drive element (5), the at least one tensioning arrangement (6) includes at least two deflecting elements (7) mounted in a moveable manner relative to the transportation apparatus, wherein the at least two deflecting elements (7) are coupled to one another.

2. A transporting apparatus comprises at least one tensioning arrangement (6) which butts against a conveying element (3) and which is guided over at least two deflecting rollers (1) and is in engagement with at least one drive element (5), the at least one tensioning arrangement (6) includes at least two deflecting elements (7) which are mounted in a moveable manner relative to the transportation apparatus, wherein the at least two deflecting elements are coupled to one another and the at least one drive element (5) is arranged between the at least two deflecting elements with respect to the conveying element.

3. The transporting apparatus as claimed in claim 1, wherein a connecting element (10) is provided between the at least two deflecting elements (7).

4. The transporting arrangement as claimed in claim 3, wherein the connecting element (10) is one of a rod, a tie rod, a cable, and a lever.

5. The transporting apparatus as claimed in claim 1, wherein the conveying element (3) comprises a circulating conveying belt which is guided over the at least two spaced-apart deflecting rollers (1) wherein the at least two deflecting elements (7) are spaced apart from one another relative to a framework (2) of the transportation device wherein the at least one drive element (5) is arranged, at a selectable distance (A) from the transportation device and the conveying element (3) wrapped around the at least one drive element.

6. The transporting apparatus as claimed in claim 1, wherein the at least two deflecting elements (7) are coupled in a common plane E1 and are movable back and forth in the plane E1.

7. The transporting apparatus as claimed in claim 1, wherein the at least two deflecting elements (7) are mounted such that they can be moved back and forth in at least two different planes E₁, E₂, and the at least two deflecting elements (7) are coupled to one another.

8. The transporting apparatus as claimed in claim 1, wherein the at least two deflecting elements (7) are spaced apart from one another and are movable along one of a path, a radius, a guide, and a linear guide.

9. The transporting apparatus as claimed in claim 1, including moving means for movement of the two coupled deflecting elements (7) shortens a tension strand (11) of the conveying element (3) in the region of one deflecting element (7) and lengthens an idle strand (12) of the conveying element (3) in the region of the other deflecting element (7).

10. The transporting apparatus as claimed in claim 7, wherein the planes E₁, E₂ are approximately parallel to the transporting apparatus.

11. The transporting apparatus as claimed in claim 1, wherein the deflecting elements (7) includes spindles (17) which rest on an at least one sliding support (19) and are movable back and forth in a longitudinal direction thereon.

12. The transporting apparatus as claimed in claim 3, wherein the deflecting elements (7), under a load (9), are displaced automatically into that position where all the force vectors are in a state of equilibrium.

13. The transporting apparatus as claimed in claim 2, wherein a connecting element (10) is provided between the at least two deflecting elements (7).

14. The transporting arrangement as claimed in claim 13, wherein the connecting element (10) is one of a rod, a tie rod, a cable, and a lever.

15. The transporting apparatus as claimed in claim 2, wherein the conveying element (3) comprises a circulating conveying belt which is guided over the at least two spaced-apart deflecting rollers (1) wherein the at least two deflecting elements (7) are spaced apart from one another relative to a framework (2) of the transportation device wherein the at least one drive element (5) is arranged, at a selectable distance (A) from the transportation device therefrom, and the conveying element (3), wrapped around the at least one drive element.

16. The transporting apparatus as claimed in claim 2, wherein the at least two deflecting elements (7) are coupled in a common plane E₁ and are movable back and forth in the plane E₁.

17. The transporting apparatus as claimed in claim 2, wherein the at least two deflecting elements (7) are mounted such that they can be moved back and forth in at least two different planes E₁, E₂, and the at least two deflecting elements (7) are coupled to one another.

18. The transporting apparatus as claimed in claim 2, wherein the at least two deflecting elements (7), are spaced apart from one another and are movable along one of a path, a radius, a guide, and a linear guide.

19. The transporting apparatus as claimed in claim 2, including moving means for movement of the two coupled deflecting elements (7) shortens a tension strand (11) of the conveying element (3) in the region of one deflecting element (7) and lengthens an idle strand (12) of the conveying element (3) in the region of the other deflecting element (7).

20. The transporting apparatus as claimed in claim 17, wherein the planes E₁, E₂ are approximately parallel to the transporting apparatus.

21. The transporting apparatus as claimed in claim 2, wherein the deflecting elements (7) includes spindles (17) which rest on an at least one sliding support (19) and are movable back and forth in a longitudinal direction thereon.

22. The transporting apparatus as claimed in claim 13, wherein the deflecting elements (7), under a load (9), are displaced automatically into that position where all the force vectors are in a state of equilibrium.
